(19) United States
(12) Patent Application Publication
(10) Pub. No.: US 2011/0280018 A1
(43) Pub. Date: Nov. 17, 2011

(54) BEAM DIRECTION CONTROLLING DEVICE AND LIGHT-OUTPUT DEVICE

(75) Inventors: Michel C. J. M. Vissenberg, Roermond (NL); Fetze Pijlman, Eindhoven (NL); Marcellinus P. C. M. Krijn, Eindhoven (NL); Siebe T. De Zwart, Valkenswaard (NL); Willem L. Ijzerman, Oss (NL)

(73) Assignee: KONINKLIJKE PHILIPS ELECTRONICS N.V., EINDHOVEN (NL)

(21) Appl. No.: 13/122,595

(22) PCT Filed: Oct. 2, 2009
(86) PCT No.: PCT/IB09/54332

§ 371 Date: Apr. 5, 2011

(30) Foreign Application Priority Data
Oct. 9, 2008 (EP) 08166168.8

(51) Int. Cl. F21V 14/04; F21V 14/00

(52) U.S. Cl. 362/277; 362/319

(57) ABSTRACT

A beam direction controlling device (22; 30; 45; 60; 80), for controlling a direction of a light-beam emitted by a light-source (21) and passing through the beam direction controlling device (22; 30; 45; 60; 80). The beam direction controlling device comprises a first optical element (23, 31; 46; 61) having first (32) and second (33) opposing faces and being configured to change a direction of a plurality of parallel light-rays (40) incident on the beam direction controlling device (22; 30; 45; 60; 80) in an incident direction (rᵢ) at the first face (32) of the first optical element (23, 31; 46; 61) to a primary direction (rₚ), different from the incident direction (rᵢ), at the second face (33) of the first optical element (23, 31; 46; 61); and a second optical element (24, 32; 47; 62) having first (36) and second (37) opposing faces, the second optical element (24, 32; 47; 62) being arranged with the first face (36) of the second optical element (24, 32; 47; 62) facing the second face (33) of the first optical element (23, 31; 46; 61), the second optical element (24, 32; 47; 62) being configured to change a direction of the plurality of light-rays from the primary direction (rₚ) at the first face (36) of the second optical element (24, 32; 47; 62) to a secondary direction (rₛ) at the second face (37) of the second optical element (24, 32; 47; 62) depending on points (41) of incidence of the light-rays on the first face (36) of the second optical element (24, 32; 47; 62). The beam direction controlling device is configured to allow relative movement between the first and second optical element for controlling the points of incidence of the light rays on the first face of the second optical element, thereby enabling control of the direction of the light-beam.

### FIELD OF THE INVENTION

The present invention relates to a beam direction controlling device, and to a light-output device comprising such a beam direction controlling device.

### BACKGROUND OF THE INVENTION

Downlights and spotlights are in very widespread use by architects, interior designers as well as end-users for creating a desired interior style.

Downlights are generally used for general illumination purposes and usually produce a relatively broad beam, whereas spotlights are typically aimed at a certain target by tilting and rotating the spotlight.

Recently, advances in lighting technology, especially in the field of light-emitting diodes (LEDs) and LED-based luminaires, have enabled flat and compact light-output devices, such as luminaires, which are easier to install and more compact and unobtrusive than conventional lighting systems.

For downlights, the use of this new type of flat luminaires is relatively straight-forward. For spotlights, however, the advantages are currently not as obvious, because the mechanical arrangements needed for controlling the direction of the light are relatively bulky in themselves and therefore largely cancel out the slim form factor obtained through the use of a flat luminaire.

### SUMMARY OF THE INVENTION

In view of the above-mentioned and other drawbacks of the prior art, a general object of the present invention is to provide an improved beam direction controlling device, and in particular a compact beam-direction device enabling simple and robust control of a direction of a light-beam passing therethrough.

According to a first aspect, the invention provides a beam direction controlling device, for controlling a direction of a light-beam emitted by a light-source and passing through the beam direction controlling device, comprising: a first optical element having first and second opposing faces and being configured to change a direction of a plurality of parallel light-rays incident on the beam direction controlling device from an incident direction at the first face of the first optical element to a primary direction, different from the incident direction, at the second face of the first optical element; and a second optical element having first and second opposing faces, the second optical element being arranged with the first face of the second optical element facing the second face of the first optical element, the second optical element being configured to change a direction of the plurality of light-rays from the primary direction at the first face of the second optical element to a secondary direction at the second face of the second optical element depending on points of incidence of the light-rays on the first face of the second optical element, wherein the beam direction controlling device is configured to allow relative movement between the first and second optical element for controlling the points of incidence of the light rays on the first face of the second optical element, thereby enabling control of the direction of the light-beam.

The beam direction controlling device may advantageously comprise movement means for enabling the above-mentioned relative movement between the first and second optical element.

“Movement means” as used herein should be understood to mean any means capable of providing the desired relative movement between the first and second optical element. Such movement means may include manually operated means, which may be provided in the form of one or several lever(s), handle(s), etc. The movement means may further include powered actuators, such as electrical motors, pneumatic or hydraulic actuators etc.

The first and second optical elements may be any optical element having the claimed properties. Advantageously, each of the first and second optical elements may be provided in the form of an optically transparent planar member, such as a plate or a foil, which may be structured to achieve the desired light-ray redirection properties.

The present invention is based on the realization that a very compact device for controlling the direction of a light-beam can be achieved by providing two optical elements in series where the first optical element deflects light-rays to hit the second optical element in a given direction in a given set of points of incidence, and the second optical element is configured to deflect those light-rays differently depending on the points of incidence.

The present inventors have further realized that such a device can be used to control the direction of the light-beam practically continuously within a given range by moving the second optical element in relation to the first optical element to get a new set of points of incidence and/or moving first and second optical elements with a constant mutual positional relationship between the optical elements to change the direction of the light-rays hitting the second optical element while keeping the points of incidence unchanged.

Accordingly, only movement in a direction perpendicular to the optical axis of the beam direction controlling device is needed, which enables the formation of a very compact beam direction controlling device which is particularly suitable for use in combination with flat and compact semiconductor light-source based light-output devices, such as flat LED-based downlights. By combining such a flat downlight with a beam direction controlling device according to embodiments of the present invention, the downlight can be converted into a controllable spotlight while sacrificing hardly any of the compactness and unobtrusiveness of the downlight.

The first and second optical elements may advantageously be arranged substantially in parallel with each other, which depending on the actual embodiment may improve the performance and/or facilitate the manufacture and assembly of the beam direction controlling device. For at least some embodiments of the beam direction controlling device according to the invention, it is expected that the best performance is achieved when the first and second optical elements are arranged within about ±10° from being arranged in parallel planes.

To limit unwanted broadening or narrowing of the light-beam emitted by the light-output device comprising a light-source and the beam direction controlling device according to embodiments of the present invention, the movement means may advantageously be configured to allow relative movement between the first and second optical elements while keeping the distance between the first and second optical elements constant.

Furthermore, each of the first and second optical elements may comprise an array of redirecting structures, whereby the relative movement required to achieve a certain change in beam direction can be kept small, which allows for the provision of a very compact beam direction controlling device, and, accordingly of a compact and unobtrusive controllable spotlight.

Generally speaking, the optical elements comprised in the beam direction controlling device according to the present invention may use any mechanism for achieving the desired redirection of the light-rays. Such mechanisms may, for example, include reflection, electrically or magnetically controlled refraction, guiding of light through total internal reflection or any combination of these and other mechanisms. However, by providing the desired redirection through an array of refractive structures, the manufacture of the beam direction controlling device can be facilitated and existing, relatively low-cost optical elements can be used.

According to one embodiment, each of the first and second optical elements may comprise a prism plate, and the beam direction controlling device may be configured to enable a relative rotation about the optical axis of the beam direction controlling device between the first and second optical elements.

In this embodiment, each of the first and second prism plates, comprised in the first and second optical elements, respectively, may deflect incident parallel light-rays by a fixed given polar deflection angle, that is, a fixed given angle relative to the optical axis of the beam direction controlling device. The resulting direction of the deflected light-rays, however, also depends on the azimuth angle of the deflected light-rays, which in turn depends on the rotation about the optical axis of the respective prism plates.

Consequently, the direction of the light-beam exiting the beam direction controlling device according to the present embodiment, that is, the polar angle as well as the azimuth angle of the light-beam can be controlled by controlling the rotations of the first and second optical elements.

For user convenience, the beam direction controlling device may be provided with movement means comprising a first user controllable actuator for enabling the user to control the relative rotation between the first and second prism plates (the relative azimuth angle), and a second user controllable actuator for enabling the user to control the joint rotation of the first and second prism plates, with the relative azimuth angle being constant.

Moreover, the first face of each of the first and second optical elements may be substantially planar and the second face of each of said first and second optical elements may have a prism structure formed thereon.

By arranging the optical elements in this way, such that the incident light-rays first hit the flat sides thereof, the formation of satellite beams in another direction than the intended direction due to total internal reflection in the optical members/prism plates can be greatly reduced.

It should be noted that the two prism plates or foils need not be identical. For example, it may be advantageous to use a slightly smaller prism angle for the prism plate/foil comprised in the second optical member, to alleviate deflection artifacts.

Additionally, stray light due to Fresnel reflections may be suppressed by providing antireflection coatings on the first and second optical members. Alternatively, or in combination, a louvre foil may be placed in between the two prism plates/foils for the same purpose. The transmission orientation of the louvre foil may advantageously coincide with the deflected beam direction between the prism plates/foils, i.e. the louvre foil may advantageously be attached to the first optical element.

According to another embodiment, the first optical element may comprise a first lenticular array comprising a plurality of focusing lenticulars; the second optical element may comprise a second lenticular array; and the beam direction controlling device may be configured to enable a relative lateral displacement between the first and second optical elements in a plane perpendicular to the optical axis of the beam direction controlling device.

In this embodiment, a light-beam is focused by each lenticular in the first lenticular array such that a plurality of parallel light-rays in the primary direction are formed, each being associated with a respective lenticular in the first lenticular array. These light-rays are then deflected by the lenticulars in the second lenticular array in a direction that depends on where these light-rays each hit a corresponding lenticular in the second lenticular array.

By using a second lenticular array having substantially the same pitch (distance between neighboring lenticulars) as the first lenticular array, a beam direction controlling device can be provided which enables controlling the direction of the beam by laterally displacing the second optical element relative to the first optical element by a maximum distance corresponding to the pitch.

Hence, to provide for a smooth and continuous control of the direction of the light-beam, the movement means may advantageously be configured to allow a maximum relative lateral displacement being smaller than or equal to the pitch of the first and second lenticular arrays.

The lenticular arrays may, furthermore, advantageously each have a pitch of 20 mm or smaller to keep the mechanical movement needed for maximum light beam deflection conveniently small.

The movement means may additionally be configured to enable changing the distance between the first and second optical elements, whereby the divergence of the light-beam can be controlled.

The desired control of the direction of the light-beam can be achieved using various configurations for the second lenticular array.

According to one example, the second lenticular array may, like the first lenticular array, comprise a plurality of focusing lenticulars. The lenticulars in the second lenticular array may, furthermore, advantageously, be more focusing (“stronger”) than the lenticulars in the first lenticular array.

In beam direction controlling devices according to the present example, simulations and experiments give that the focal length of the focusing lenticulars in the first lenticular array may advantageously be in the range of between 2 and 10 times the pitch of the first lenticular array. The focal length of the lenticulars in the second lenticular array may then preferably be between 0.5 and 1.5 times the pitch of the first (and second) lenticular array. Hereby, a relatively large angular displacement of the light-beam can be achieved through a relatively small lateral displacement of the second optical element in relation to the first optical element.

According to another example, each of the lenticulars in the second lenticular array may comprise a first portion configured to provide total internal reflection of the light-rays impinging on the second optical element in the primary direction; and a second portion configured to refract the light-rays.

Hereby, the lenticulars in the second lenticular array can be made very strong, whereby larger deflection angles can be achieved.

According to yet another example, the second lenticular array may comprise a plurality of diverging, or negative, lenticulars, whereby substantially the same redirecting effect as with focusing lenticulars can be achieved.

Furthermore, the beam direction controlling device may additionally comprise a further optical element arranged between the first and second optical elements, the further optical element having a refractive index differing from an average refractive index of the first and second optical element by less than 0.3.

Hereby, even shorter focal lengths can be achieved, allowing an even more compact beam direction controlling device. Additionally, the optical quality of the lenticulars can be improved.

An additional advantageous effect achieved by providing such a further optical member is that spurious Fresnel reflections can be reduced.

Since the refractive index of the first and second optical members will generally be around 1.5, the refractive index of the further optical element may in most cases be between 1.2 and 1.8.

For ease of manufacturing and handling, the further optical element may preferably be provided in the form of a liquid or a gel.

For embodiments of the present invention in which each of the first and second optical elements comprises a lenticular array, it may be advantageous to provide a further, third optical element comprising a lenticular array between the first and second lenticular arrays.

By properly selecting the properties of the lenticulars in the third lenticular array, an improved beam controlling performance of the beam controlling device can be achieved. In particular, a larger maximum beam deflection angle can be achieved.

The focal length of the lenticulars of the third lenticular array may preferably be chosen such that the third lenticular array images the first lenticular array onto the second lenticular array.

Moreover, the third lenticular array may advantageously be placed in the focal plane of the first lenticular array which coincides with the focal plane of the second lenticular array.

In various embodiments, the movement means may additionally be configured to move the third optical element in relation to the first optical element, whereby an even further maximum beam deflection angle can be achieved.

To obtain even larger deflection angles, several more optical elements, each comprising a lenticular array can be stacked. For example, one additional lenticular array may be positioned in the focal plane of the first lenticular array and another additional lenticular array may be positioned in the focal plane of the second lenticular array. The optical properties of the stack of multiple lenticular arrays may advantageously be such that the first lenticular array is imaged onto the second lenticular array. Furthermore, the movement means may be configured in such a way that the lateral positions of one of several of the lenticular arrays can be tuned with respect to the lateral position of the first lenticular array.

Furthermore, the beam direction controlling device according to the present invention may advantageously be included in a light-output device, further comprising a light-source arranged to emit light passing through the beam direction controlling device.

As mentioned above, such a light-output device may advantageously be a controllable spotlight.

### BRIEF DESCRIPTION OF THE DRAWINGS

These and other aspects of the present invention will now be described in more detail, with reference to the appended drawings showing currently preferred embodiments of the invention, wherein:

FIGS. 1a-b show prior art lighting solutions;

FIG. 2 schematically illustrates a light-output device comprising a beam direction controlling device according to an embodiment of the present invention;

FIGS. 3a-c schematically illustrate a beam direction controlling device according to embodiments of the present invention in different beam direction controlling states;

FIGS. 4a-b schematically illustrate a first embodiment of the beam direction controlling device according to the present invention in different beam direction controlling states;

FIGS. 5a-d schematically illustrate exemplary beam direction controlling states obtained using the beam direction controlling device in FIGS. 4a-b;

FIGS. 6a-b schematically illustrate a second embodiment of the beam direction controlling device according to the present invention in different beam direction controlling states;

FIGS. 7a-c are cross-sectional views of portions of the beam direction controlling device in FIGS. 6a-c, schematically illustrating the working mechanism of the beam direction controlling device;

FIG. 8 schematically illustrates relations between various parameters of the beam direction controlling device in FIGS. 7a-b;

FIGS. 9a-c are cross-section views schematically illustrating the use of an alternative type of lenticulars in the second lenticular array;

FIG. 10 is a cross-sectional view schematically illustrating a further exemplary configuration of the beam direction controlling device in FIGS. 6a-c;

FIGS. 11a-b schematically illustrate yet another exemplary configuration of the beam direction controlling device in FIGS. 6a-c;

FIGS. 12a-c schematically illustrate various alternative lenticular array configurations; and

FIGS. 13a-b schematically illustrate a third embodiment of the beam direction controlling device according to the present invention in different beam direction controlling states.

### DESCRIPTION OF PREFERRED EMBODIMENTS

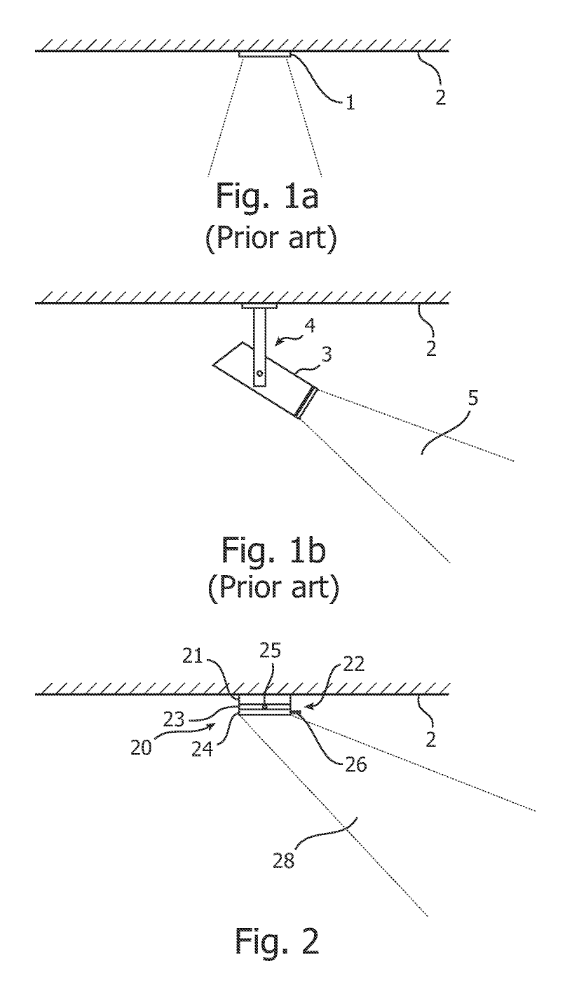

FIG. 1a schematically illustrates a flat and compact downlight 1, which is mounted on a ceiling 2 to emit light straight down. Such a downlight 1 may, for example, be based on semiconductor light-sources, such as LEDs, and a light-guide arrangement for conditioning (mixing and distributing) the light emitted by the light-sources.

Furthermore, FIG. 1b schematically illustrates a conventional spotlight 3, which is mounted on the ceiling 2 via an ordinary mechanical beam direction controlling device 4. By manually tilting and rotating the spotlight 3, the direction of the light-beam 5 emitted thereby can be controlled at will.

If one would straight-forwardly combine the flat and compact downlight 1 in FIG. 1a with the mechanical beam direction controlling device 4 in FIG. 1b, one would arrive at a spotlight based on the flat downlight 1 in FIG. 1a. However, many of the features of the downlight 1 in FIG. 1a, that make it attractive for deployment in various lighting solutions, would then be lost.

In order to provide a user controllable spotlight while maintaining many of the attractive features of the downlight 1 in FIG. 1a, various embodiments of the beam direction controlling device according to the present invention can be used as is schematically illustrated in FIG. 2.

In FIG. 2, a light-output device in the form of a controllable spotlight 20 is shown comprising a flat and compact light-emitting device 21 similar to the downlight 1 in FIG. 1a, and a beam direction controlling device 22 according to an embodiment of the present invention arranged such that light emitted by the light-emitting device 21 passes through the beam direction controlling device when the spotlight 20 is in operation.

The beam direction controlling device 22 in FIG. 2 comprises first 23 and second 24 optical elements, each of which is moveable in a plane parallel to the ceiling 2 using the respective movement means in the form of first 25 and second 26 actuators, by which the user can move the first 23 and second 24 optical elements independently of each other.

Through operation of the actuators 25, 26, the direction of the light-beam 28 emitted by the spotlight 20 can be controlled.

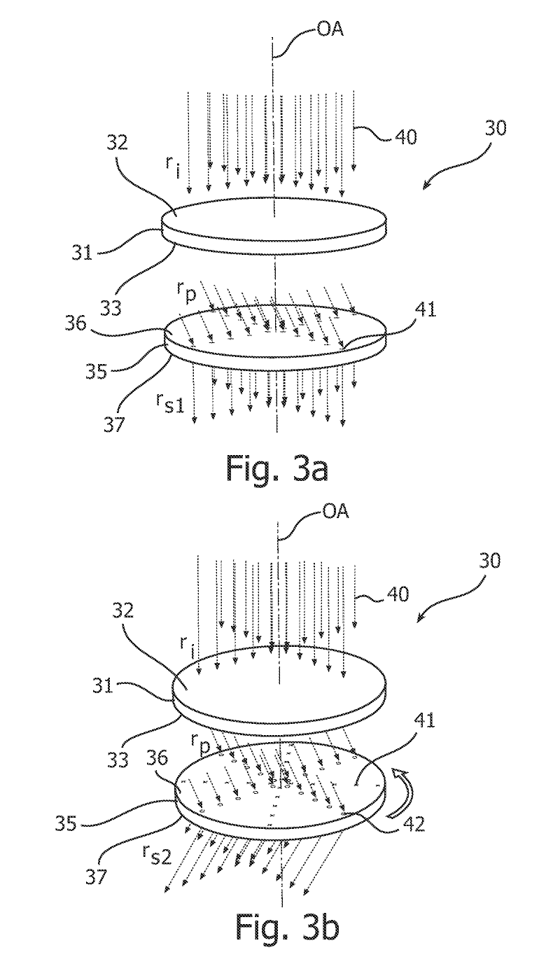

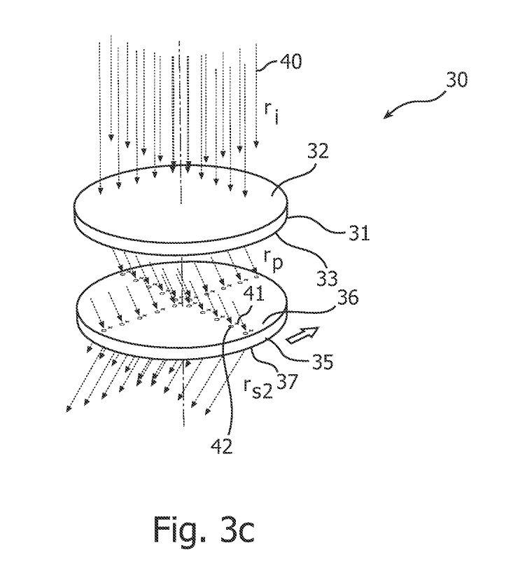

With reference to FIGS. 3a-c, the basic principle of operation of the beam direction controlling device according to the present invention will now be described.

In FIG. 3a, the beam direction controlling device 30 is shown in a first beam direction controlling state. Further, FIG. 3b and FIG. 3c, respectively show two different basic principles for taking the beam direction controlling device 30 to other beam direction controlling states.

Turning first to FIG. 3a, the beam direction controlling device 30 comprises a first optical element 31 having a first face 32 and a second face 33 and a second optical element 35 having a first face 36 and a second face 37. The second optical element 35 is arranged in a plane substantially in parallel with the first optical element 31 with the first face 36 of the second optical element 35 facing the second face 33 of the first optical element 31.

As is schematically illustrated in FIG. 3a, the first optical element 31 is configured to change the direction of a plurality of incident parallel light-rays 40 from an incident direction rᵢ at the first face 32 of the first optical element 31 to a primary direction rₚ at the second face 33 of the first optical element 31.

The light-rays thus hit the first face 36 of the second optical element 35 in the primary direction rₚ on a corresponding plurality of points of incidence 41, denoted by ‘x’ in FIG. 3a.

Depending on the points of incidence 41, the second optical element 35 is configured to change the direction of the light-rays hitting the first face 36 thereof from the primary direction rₚ to a secondary direction rₛ₁, which in the beam-direction controlling state illustrated in FIG. 3a is parallel with the optical axis OA of the beam direction controlling device 30.

Depending on the configuration of the second optical element 35, the desired change in redirection of a plurality of parallel light-rays from a primary direction to a different secondary direction rₛ₂ can be achieved through rotary movement, linear movement, or a combination thereof, of the second optical element 35 in relation to the first optical element 31.

With reference to FIG. 3b, an exemplary case will be explained in which the second optical member 35 is configured to achieve the desired change in redirection through rotary movement of the second optical element 35 in relation to the first optical member 31.

In FIG. 3b, the first optical member 31 has been maintained in the same position as in FIG. 3a. Hence, the incident light-rays 40 hitting the first face 32 of the first optical element 31 in the incident direction rᵢ are redirected to the same primary direction rₚ as in FIG. 3a.

Since the second optical element 35 in FIG. 3b has been rotated relative to the first optical element 31, the light-rays in the primary direction rₚ now hit the first face 36 of the second optical element 35 on a different set of points of incidence 42, denoted ‘o’. The points of incidence 41 from before the rotation of the second optical member 35 are shown in FIG. 3b to illustrate that there has been a change as compared to the situation in FIG. 3a.

As is schematically illustrated in FIG. 3b, the change in points of incidence results in a change in secondary direction, from rₛ₁ in FIG. 3a to rₛ₂ in FIG. 3b. Accordingly, the beam direction controlling device 30 has been put in a second beam direction controlling state through the rotation of the second optical element 35 relative to the first optical element 31.

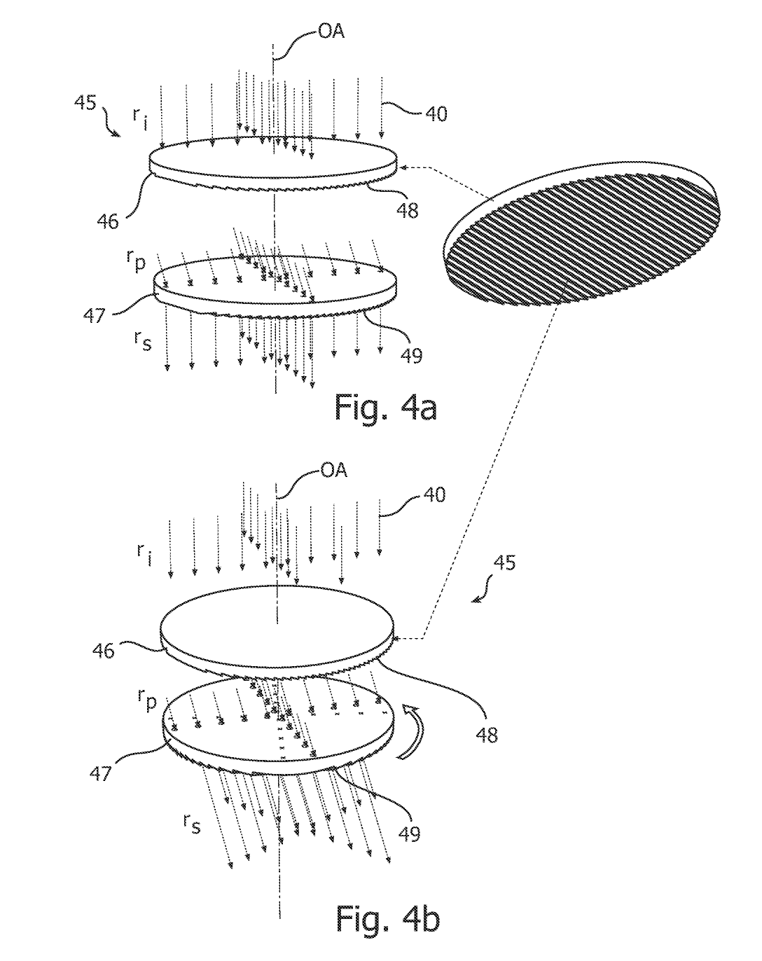

A more detailed description of a beam direction controlling device configured to control the beam direction in response to a rotation of the second optical element in relation to the first optical element will be provided below with reference to FIGS. 4a-b.

With reference to FIG. 3c, a different case is shown in which the desired redirection, from the primary direction rₚ to the secondary direction rₛ₂ is instead achieved by translating the second optical element 35 laterally relative to the first optical member 31 as is indicated by the arrow in FIG. 3c.

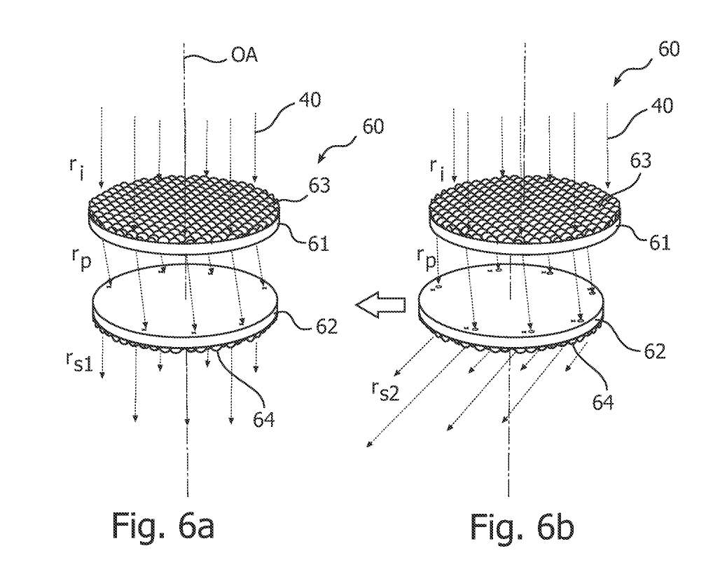

A more detailed description of a beam direction controlling device configured to control the beam direction in response to a lateral translation of the second optical element in relation to the first optical element will be provided below with reference to FIGS. 6a-b.

FIGS. 4a-b schematically illustrate a first embodiment of the beam direction controlling device according to the present invention in different beam direction controlling states.

In FIGS. 4a-b, the first 46 and second 47 optical elements comprised in the beam direction controlling device 45 are provided in the form of prism plates, or prism foils, as is schematically indicated in the figures.

Such prism plates or foils are currently used in liquid crystal displays, LCDs, to aim the image output by the LCD in a given, fixed direction towards the expected position of a viewer.

By arranging two such prism plates in the manner indicated in FIGS. 4a-b, both the azimuth angle and the polar angle of the light-beam can be determined at will (within a certain polar angular range) by appropriately rotating the first 46 and second 47 optical elements.

In both FIG. 4a and FIG. 4b, the first optical element 46 is oriented in such a way that the incident light-rays 40 are redirected from the initial direction rᵢ to the primary direction as is schematically illustrated in FIGS. 4a-b. In particular, the redirection from the initial direction rᵢ to the primary direction rₚ is achieved by rotating the first optical element 46 such that the prismatic structures 48 on the second face thereof are oriented to refract the incident rays 40 in the desired direction.

In FIG. 4a, the second optical element 47 is arranged in anti-parallel (the prismatic structures 49 of the second optical element 47 being rotated 180° relative to the prismatic structures 48 of the first optical element 46), such that the second optical element 47 redirects the light-rays incident thereon by the same magnitude and in the opposite direction as compared to the first optical member 46. As is schematically illustrated in FIG. 4a, the resulting beam deflection is zero, that is, the secondary direction rₛ is the same as the incident direction rᵢ.

By rotating the second optical member 47 relative to the first optical member 46, the vector sum of the deflections of the first 46 and second 47 optical members results in a non-zero beam deflection, that is, the secondary direction rₛ being different from the incident direction rᵢ.

This is schematically shown in FIG. 4b, where the difference in azimuth angle between the prismatic structures 48, 49 of the first 46 and second 47 optical elements is reduced by about 60° as compared to the situation illustrated in FIG. 4a, that is, the prismatic structures 49 of the second optical element 47 are now rotated about 120° relative to the prismatic structures 48 of the first optical element 46.

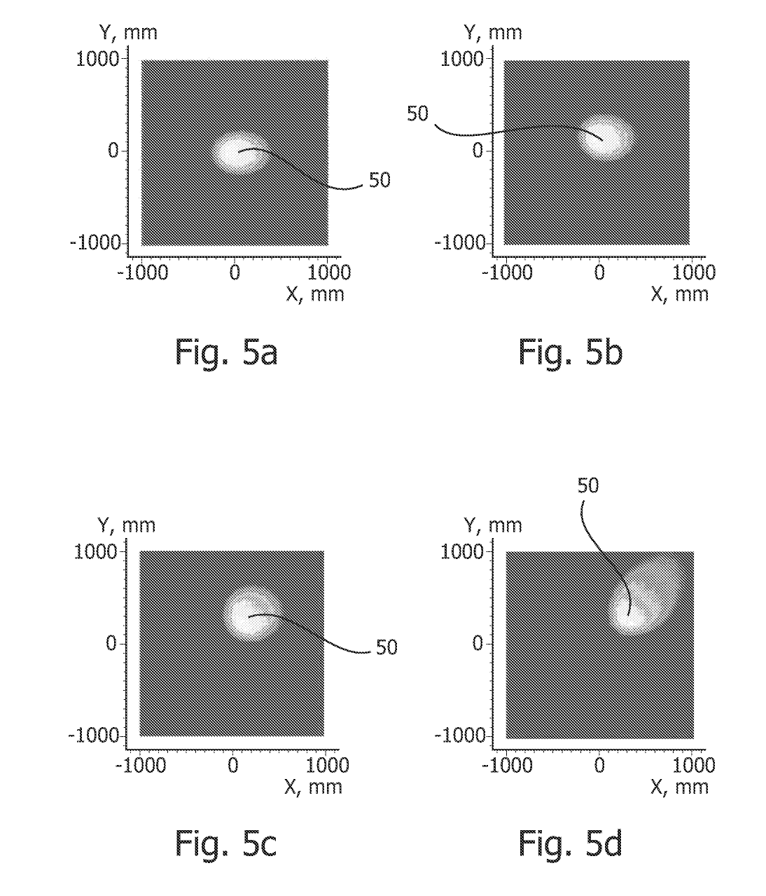

FIGS. 5a-d illustrate exemplary beam direction controlling states obtained by rotating the second optical member 47 relative to the first optical member 46 in the beam direction controlling device 45 of FIGS. 4a-b.

FIG. 5a shows the spot 50 obtained by the light-beam emitted by a spotlight equipped with the beam direction controlling device 45 of FIG. 4a. In this first beam controlling state, the difference in azimuth angle between the first 46 and second 47 optical elements is approximately 180°, resulting in a very small deflection of the light-beam, namely a polar angle of 3°, and an azimuth angle of 0°.

In FIG. 5b, a second beam direction controlling state is illustrated, in which a difference in azimuth angle between the first 46 and second 47 optical elements of 150° results in a deflected light-beam having a polar angle of 10°, and an azimuth angle of 61°.

In FIG. 5c, a third beam direction controlling state is illustrated, in which a difference in azimuth angle between the first 46 and second 47 optical elements of 120° results in a deflected light-beam having a polar angle of 20°, and an azimuth angle of 57°.

Finally, FIG. 5d illustrates a fourth beam direction controlling state, in which a difference in azimuth angle between the first 46 and second 47 optical elements of 90° results in a deflected light-beam having a polar angle of 31°, and an azimuth angle of 47°.

As is clear from the above-described exemplary beam direction controlling states, a rotation of the second optical member 47 with the first optical member 46 being stationary results in a change in polar angle as well as azimuth angle.

From this follows that, in the presently described embodiment of the beam direction controlling device according to the present invention, the first optical element 46 may also be rotatable to enable a free control of the beam direction within the cone defined by a maximum polar angle determined by the configuration of the particular beam direction controlling device.

The control of the direction of the light-beam through independently rotating the first 46 and second 47 optical elements by appropriate angles about the optical axis of the beam direction controlling device might be counter-intuitive to the user because a rotation of each of the optical elements 46, 47 leads to a change in azimuth and polar angle.

To facilitate user control of the beam direction controlling device according to the present embodiment, the moving means (not shown in FIGS. 4a-b) may have first and second actuators, such as handles of levers, and may be configured in such a way that the operation of the first actuator results in a rotation of the first 46 and second 47 optical element around the optical axis OA, which is opposite in sign for the first 46 and second 47 optical elements. This leads to a significant change in the polar angle, but also in the azimuth angle. By operating the second actuator, the first 46 and second 47 optical element may then be rotated around the optical axis OA with a fixed azimuth angle difference therebetween. This leads to a change in the azimuth angle of the light-beam only.

It has been noted that beam splitting and beam deformation are less pronounced when either a narrower beam and/or a smaller prism angle of the first 46 and/or the second 47 optical element are used. Such improved performance may also be achieved by using more than two optical elements, each comprising a prism plate. This can enlarge the deflection angle and/or reduce beam splitting and beam deformation.

Finally, the first 46 and the second 47 optical elements need not be identical. For example, it may be advantageous to use a slightly smaller prism angle for the second optical element 47, to alleviate deflection artifacts.

FIGS. 6a-b schematically illustrate a second embodiment of the beam direction controlling device according to the present invention in different beam direction controlling states.

In FIGS. 6a-b, the first 61 and second 62 optical elements comprised in the beam direction controlling device 60 comprise lenticular arrays, as is schematically indicated in the figures.

By arranging two lenticular arrays in the manner indicated in FIGS. 6a-b, both the azimuth angle and the polar angle of the light-beam can be determined at will (within a certain polar angular range) by appropriately laterally translating the second optical element 62 in relation to the first optical element 61.

Since each lenticular 63 comprised in the first optical element 61 in FIG. 6a is a positive lens, the incident light hitting a lenticular 63 will be converged by the lenticular 63.

Considering a plurality of parallel light-rays 40, each hitting a respective lenticular 63 in a given position in an incident direction rᵢ, each of these light-rays will have its direction changed by its respective lenticular, resulting in each of the light-rays being redirected to a primary direction rₚ as is indicated in FIGS. 6a-b.

In FIG. 6a, the second optical element 62 is positioned in such a way that each of the light-rays travelling in the primary direction rₚ hits a respective one of the lenticulars 64 in the second optical elements 62 in a position resulting in a redirection of the light-ray from the primary direction rₚ to a secondary direction rₛ₁ being equal to the incident direction rᵢ.

This occurs when the first 61 and second 62 optical elements are positioned relative to each other in such a way that the optical axes of lenticulars 63, 64 in the first 61 and second 62 optical elements coincide.

When laterally displacing the second optical element 62 relative to the first optical element 61 as is indicated in FIG. 6b, the light-rays 40 are redirected to another secondary direction rₛ₂ as is schematically illustrated in FIG. 6b.

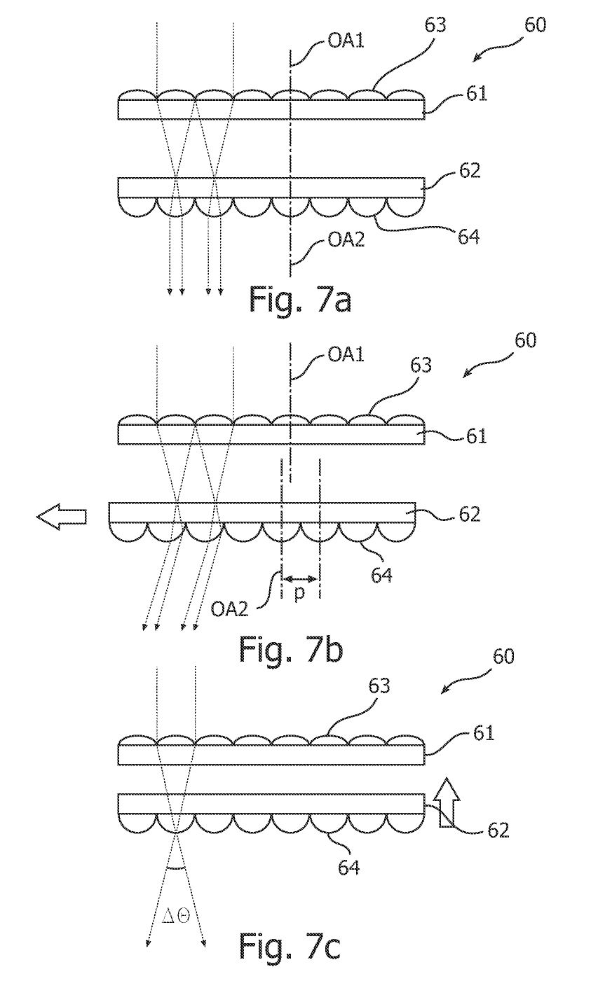

With reference to FIGS. 7a-c, the beam direction controlling capability of the beam direction controlling device 60 in FIGS. 6a-b will now be described in more detail.

FIGS. 7a-c are schematic cross-sectional views of a first exemplary configuration of the beam-direction controlling device 60 in FIGS. 6a-b, in which both the lenticulars 63 comprised in the first optical element 61 and the lenticulars 64 comprised in the second optical element 62 are positive lenses, the lenticulars 64 in the second optical element 62 being “stronger” than the lenticulars 63 in the first optical element 61.

The focal lengths of the lenticulars 63, 64 differ in order to increase the lateral distance which the second optical element 62 can be moved relative to the first optical element 61 without light-rays traversing the wrong lenticular and thus creating ghost images of the spot.

In the situation illustrated in FIG. 7a, the optical axis OA1 of the lenticulars 63 in the first optical element 61 coincides with the optical axis OA2 of the lenticulars 64 in the second optical element 62. Furthermore, the first 61 and second 62 optical elements are spaced apart a distance substantially corresponding to the focal length of the lenticulars 63 in the first optical element 61.

As can be seen in FIG. 7a, there is no redirection of the incident light-beam.

In FIG. 7b, the second optical element 62 is moved laterally relative to the first optical element 61 (to the left in FIG. 7b), which results in a situation where the optical axes OA1, OA2 of the lenticulars 63, 64 in the first 61 and second 62 optical members no longer coincide.

This results in a deflected light-beam, as indicated in FIG. 7b.

As is immediately apparent from FIGS. 7a-b, the direction of the light-beam can be controlled freely within a cone defined by the maximum polar angle by laterally moving the second optical element 62 relative to the first optical element within half the pitch p/2 in any direction from the state illustrated in FIG. 7a.

Besides controlling the direction of the light-beam as illustrated in FIGS. 7a-b, the divergence of the light-beam can also be controlled by changing the distance between the first 61 and second 62 optical elements.

In the example shown in FIG. 7c, the lenticulars 64 of the second optical element are located in the focal plane of the lenticulars 63 of the first optical element 61. The advantage in this case is that, although the beam divergence now becomes relatively large, the beam deflection can also be relatively large. For any person skilled in the art it is clear that for other distances one can obtain even higher beam divergence angles. One can even create an additional focus beyond the second optical element 62.

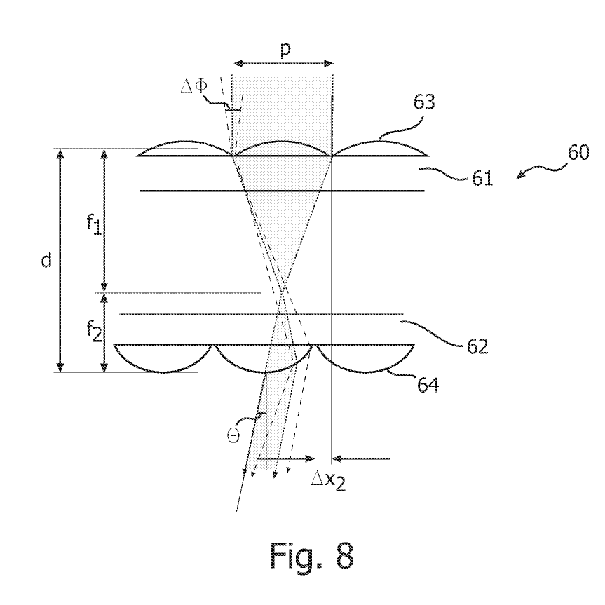

For the sake of completeness, a detailed account of several relations that exist between the parameters that define the geometry of the beam direction controlling device according to various embodiments of the present invention, and the resulting beam deflection and beam divergence will now be provided with reference to FIG. 8.

The relation between the beam deflection angle θ resulting from a shift Δx₂ of the second optical element 62 in relation to the first optical element 61 is given by:

$$tan ( θ ) = \frac{Δ {x}_{2}}{{f}_{2}}$$

In this expression, f₂ is the focal length of the lenticulars 64 comprised in the second optical element 62.

The maximum allowable lateral shift Δx₂ of the second optical element 62 in relation to the first optical element 61 is obtained from the following relation (assuming d≧f₁):

$$Δ {x}_{2 , max} = \frac{p}{2} ( 1 - \frac{{f}_{2}}{{f}_{1}} ) - ( {f}_{1} + {f}_{2} ) tan ( \frac{Δ ϕ}{2} ) .$$

In this relation, p is the lenticular pitch (considered to be equal for both lenticular arrays), d is the distance between the two optical elements 61, 62, and Δφ is the beam spread of the collimated light which is incident on the beam direction controlling device 60.

In case the displacement Δx₂ exceeds this value, some of the rays will traverse neighboring lenticulars and will be deflected into the wrong direction, giving rise to ghost images of the spot.

The maximum beam displacement is then obtained from:

$$tan ( {θ}_{max} ) = \frac{Δ {x}_{2 , max}}{{f}_{2}}$$

Let Δθ be the beam divergence (cf FIG. 7c). This beam divergence can be obtained from the relation:

$$tan ( \frac{Δθ}{2} ) = \sqrt{{[ \frac{p}{2} \cdot \frac{d - {f}_{1} - {f}_{2}}{{f}_{1} {f}_{2}} ]}^{2} + {tan}^{2} ( \frac{Δ ϕ}{2} )} .$$

Here, f₁ is the focal length of the lenticulars 63 of the first optical element 61.

It is clear that the beam divergence can be adjusted simply by adjusting the distance between the two optical elements 61, 62.

Note also that all spatial dimensions scale linearly with the lens pitch p. In other words, the smaller the lens pitch, the smaller the mechanical displacements needed to achieve a certain beam deflection or beam divergence.

As a typical example provided for illustration purposes only, consider the following. Let f₁=4p, f₂=p, and Δφ=6°. In that case, θₘₐₓ=6.4°, Δθ=15°.

Note that, when immersion-type lenses are used, f₂ can in principle be as small as f₂=p/n with n being the index of refraction of the immersion material. This enables one to increase the maximum beam displacement θₘₐₓ.

In view of the discussion provided above in connection with FIG. 8, it can be deduced that the focal length of the lenticulars 63 of the first optical element 61 may advantageously be in the range of 2-10 times the lenticular pitch p. Furthermore, the focal length of the lenticulars 64 of the second optical element 62 may advantageously be 0.5-1.5 times the lenticular pitch p. Moreover, the distance between the optical elements 61, 62 may advantageously be tunable between 0-20 times the lenticular pitch p.

Preferably, the lenticular pitch p may be smaller than 20 mm to keep the mechanical movements of the second optical element 62 in relation to the first optical element 61 within a convenient range.

Although the present embodiment of the beam direction controlling device according to the present invention has so far mainly been described with reference to first 61 and second 62 optical elements each comprising lenticular arrays with positive lenticulars 63, 64, it should be noted that other lenticular configurations may perform equally well.

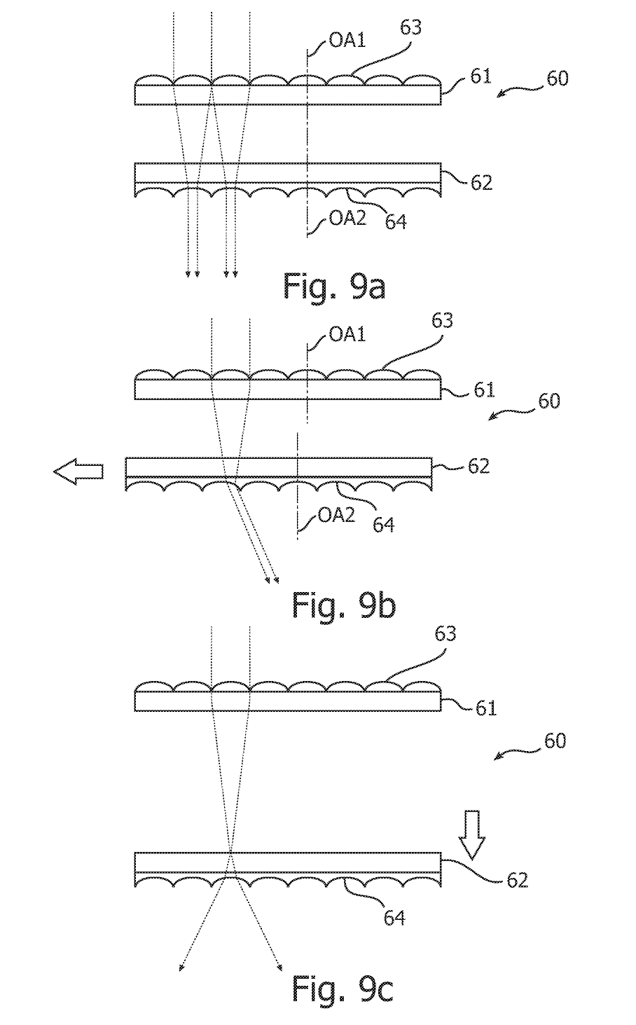

In FIGS. 9a-c, one such other lenticular configuration is shown, in which the lenticulars 64 of the second optical element 62 are negative lenticulars.

As is evident from the figures, this configuration also enables the desired beam direction control.

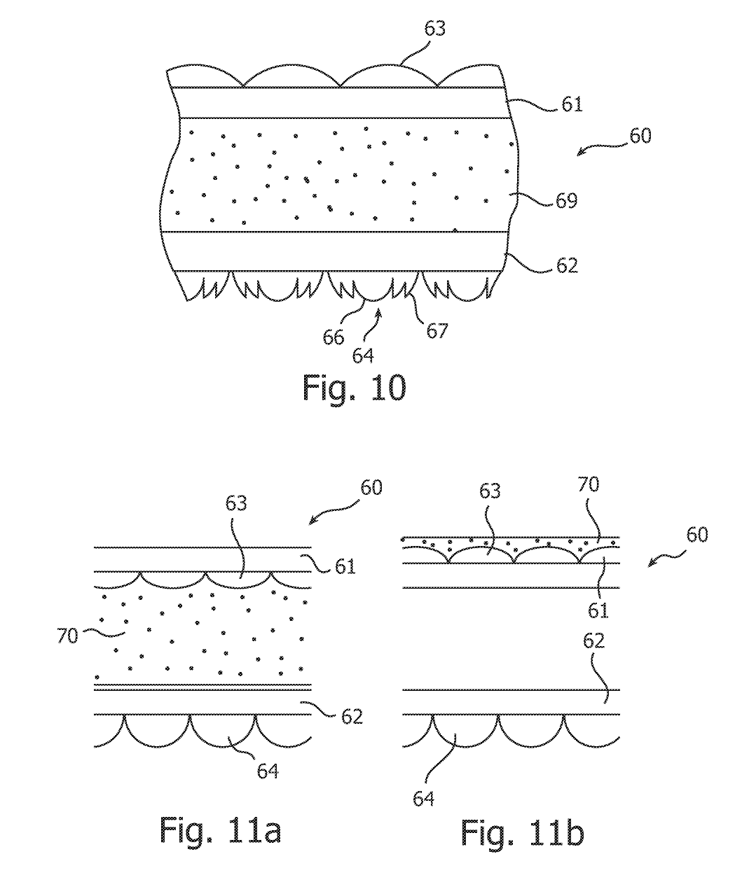

In FIG. 10, yet another lenticular configuration is shown, in which the lenticulars 64 of the second optical element 62 are based on a combination of refraction for the centrally located portion 66 of each lenticular 64, and total internal reflection, TIR, for the peripheral portion 67 of each lenticular 64. In this way “stronger” lenticulars (lenticulars having a larger numerical aperture NA) can be created. Hereby, larger deflection angles can be obtained.

As is also shown in FIG. 10, the space in between the first 61 and second 62 optical elements may be filled with a further optical element 69 having a refractive index n_{f} that differs from that of air.

Preferably, the refractive index n_{f} of the further optical element 69 may be close to that of the first 61 and second 62 optical elements (in practical implementations, this may imply a refractive index n_{f} close to 1.5).

Through the provision of the further optical element 69, each lenticular 64 in the second optical element 62 becomes a so-called immersion-type lenticular, allowing for even shorter focal lengths. An additional advantage is that spurious Fresnel reflections may be reduced. Preferably the medium in between the lenses may be a liquid or a gel.

Furthermore, as is schematically illustrated in FIGS. 11a-b, in all of the above-described illustrative examples of the lenticular-based beam-controlling device 60, the lenticular surfaces of the first optical element 61 may be in contact with a material 70 having a refractive index n_{f} that differs but is close to that of the first optical member 61. For example, let the refractive index of the material the lenticulars 63 are made of be n=1.6. Let the refractive index n_{f} of the material in contact with the lenticular surfaces be n_{f}=1.4. The difference is Δn=0.2. The result is that the optical quality of the lenticular array is improved compared to the case were one uses air as the medium in contact with the lenticular surfaces (Δn=0.5).

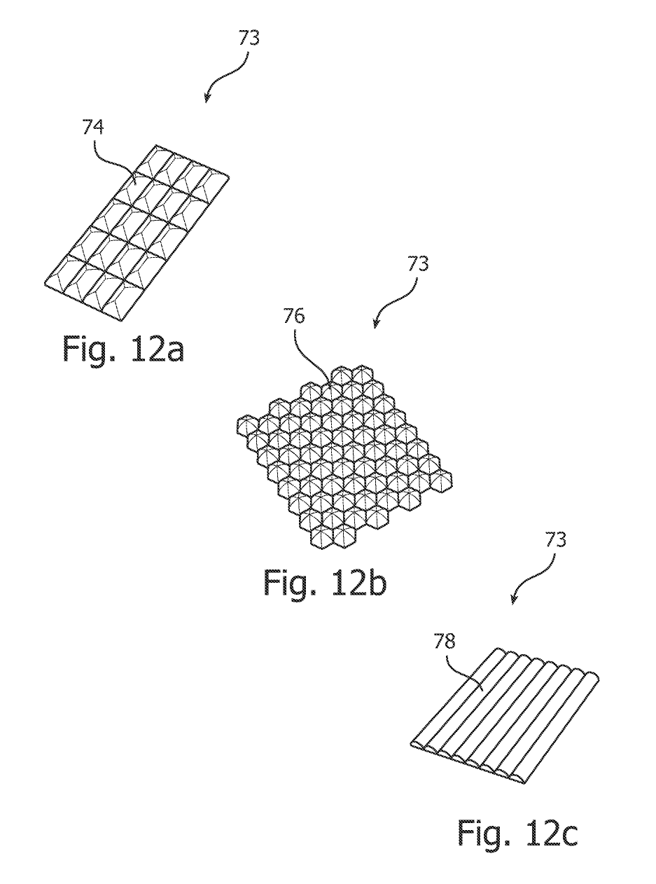

FIGS. 12a-c schematically illustrate a few alternative lenticular array configurations useable in one or both of the first 61 and second 62 optical elements comprised in the beam direction controlling device.

FIG. 12a schematically shows a lenticular array 73 comprising a plurality of lenticulars 74, each having different dimensions in the horizontal and vertical directions thereof, and hence different focal lengths in the horizontal and vertical directions.

FIG. 12b schematically shows a lenticular array 75 comprising a plurality of hexagonal lenticulars 76.

FIG. 12c schematically shows a lenticular array 77 comprising a plurality of elongated lenticulars 78.

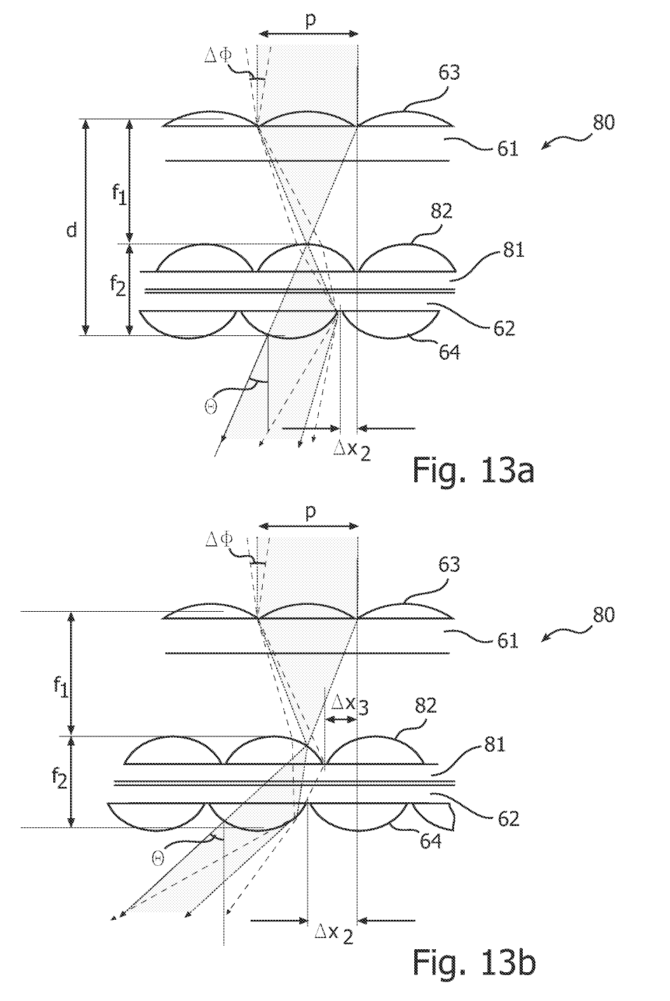

Finally, with reference to FIGS. 13a-b, a third embodiment of the beam direction controlling device according to the present invention will now be described.

As can be seen in FIGS. 13a-b, the beam-direction controlling device 80 according to the present third embodiment differs from the previously described beam direction controlling devices in that a third optical element 81, in the form of a third lenticular array in between the first 61 and second 62 optical elements (referring also to FIG. 8). The focal length of the lenticulars 82 in the third lenticular array is chosen such that the third lenticular array 81 images the first lenticular array 61 onto the second lenticular array 62. Preferentially, the third lenticular array 81 is placed in the focal plane of the first lenticular array 61 which coincides with the focal plane of the second lenticular array 62.

As is illustrated in FIG. 13a, the function of the lenticulars 82 in the third lenticular array 81 is to make a point-to point image of the lenticulars 63 in the first lenticular array 61 onto the lenticulars 64 in the second lenticular array 62. All light-rays within a certain angular range passing through a point on a lenticular 63 in the first optical element 61 are imaged onto one point on a corresponding lenticular 64 in the second optical element 62. This way the “footprint” of a light-beam on the second optical element 62 remains as small as possible. As a result, the angular spread of the beam does not decrease the maximum allowable shift in beam direction.

The lenticulars 82 in the third optical element 81 may advantageously have a focal length, f₃, equal to:

$${f}_{3} = \frac{{f}_{1} {f}_{2}}{{f}_{1} + {f}_{2}}$$

To achieve the desired deflection of the light-beam, the second optical element 62 can be moved in relation to the first optical element 61 as is schematically indicated by Δx₂ in FIG. 13a. In the beam controlling state illustrated by FIG. 13a, the third optical element 81 is not displaced in relation to the first optical element 61.

The relation between the beam deflection angle θ resulting from a shift Δx₂ of the second optical element 62 in relation to the first optical element 61, as shown in FIG. 13a, is given by:

$$tan ( θ ) = \frac{Δ {x}_{2}}{{f}_{2}} .$$

The maximum allowable shift Δx₂ is obtained from the following relation:

$$Δ {x}_{2 , max} = \frac{p}{2} ( 1 - \frac{{f}_{2}}{{f}_{1}} ) .$$

Note that the term containing Δφ is absent.

The maximum beam displacement is again obtained from:

$$tan ( {θ}_{max} ) = \frac{Δ {x}_{2 , max}}{{f}_{2}} .$$

As a typical example, consider the following. Let f₁=4p, f₂=p, and Δφ=6°. In that case, θₘₐₓ=20.6°.

By adding the third optical element 81 a significant increase in the maximum deflection angle is thus obtained.

In FIG. 13b, the beam direction controlling device 80 according to the present embodiment of the invention is shown in another state, in which, to deflect the light-beam, not only second optical element 62 is shifted by an amount Δx₂, but also third optical element 81 is shifted by an amount Δx₃ (both in relation to the first optical element 61).

Also in this case, the relation between the beam deflection angle θ resulting from a shift Δx₂ of the second optical element in relation to the first optical element 61 is given by:

$$tan ( θ ) = \frac{Δ {x}_{2}}{{f}_{2}} .$$

Note that, somewhat surprisingly, Δx₃ does not enter the equation. Still, shifting the third optical element 81 is beneficial because it allows for a larger shift of the second optical element 62. The role of the third optical element 81 is now to simultaneously image the first optical element 61 onto the second optical element 62 and to “pre-” deflect the beam. The maximum allowable shift Δx₃ is given by:

$$Δ {x}_{3 , max} = \frac{p}{2} - {f}_{1} tan ( \frac{Δ ϕ}{2} ) .$$

The maximum allowable shift Δx₂ (supposing Δx₃=Δx_{3,max}) is given by:

$$Δ {x}_{2 , max} = p - ( {f}_{1} + {f}_{2} ) tan ( \frac{Δ ϕ}{2} ) .$$

The maximum beam displacement is again obtained from:

$$tan ( {θ}_{max} ) = \frac{Δ {x}_{2 , max}}{{f}_{2}} .$$

As a typical example, consider the following. Let f₁=4p, f₂=p, and Δφ=6°. In that case, θₘₐₓ=36.4°.

By allowing a shift of the third optical element 81 in relation to the first optical element 61, an additional significant increase in the maximum deflection angle is thus obtained.

The term “substantially” herein, such as in “substantially parallel”, will be understood by the person skilled in the art. Likewise, the term “about” will be understood. The terms “substantially” or “about” may also include embodiments with “entirely”, “completely”, “all”, “exactly, etc., where appropriate. Hence, in embodiments the adjective substantially may also be removed. For instance, the term “about 2°”, may thus also relate to “2°”.

The person skilled in the art will realize that the present invention is by no means limited to the preferred embodiments. For example, it may be advantageous to cover the region in between the lenticulars 64 of the second optical element with a black matrix to achieve larger deflection angles. Moreover, the first 61 and second 62 optical elements may be coated with an anti-reflection coating to avoid spurious Fresnel reflections from the surfaces of the lenticular arrays. Furthermore, it may be advantageous to include even further optical elements, which may include any one of the above-described prism plates and/or lenticular arrays, between the first and second optical elements. The mere fact that certain measures are recited in mutually different dependent claims does not indicate that a combination of these measured cannot be used to advantage. Any reference signs in the claims should not be construed as limiting the scope.

1. A beam direction controlling device, for controlling a direction of a light-beam emitted by a light-source and passing through said beam direction controlling device, comprising:
a first optical element having first and second opposing faces and being configured to change a direction of a plurality of parallel light-rays incident on said beam direction controlling device in an incident direction at said first face of the first optical element to a primary direction, different from said incident direction, at said second face of the first optical element; and
a second optical element having first and second opposing faces, said second optical element being arranged with the first face of the second optical element facing the second face of the first optical element, said second optical element being configured to change a direction of said plurality of light-rays from said primary direction at said first face of the second optical element to a secondary direction at said second face of the second optical element depending on points of incidence of said light-rays on said first face of the second optical element,
wherein said beam direction controlling device is configured to allow relative movement between said first and second optical element for controlling the points of incidence of the light rays on said first face of the second optical element, thereby enabling control of the direction of said light-beam.

2. The beam direction controlling device according to claim 1, wherein said beam direction controlling device is configured to allow relative movement between said first and second optical elements while maintaining a fixed distance therebetween.

3. The beam direction controlling device according to claim 1, wherein each of said first and second optical elements comprises an array of redirecting structures.

4. The beam direction controlling device according to claim 3, wherein each redirecting structure is a refractive structure redirecting said rays through refraction.

5. The beam direction controlling device according to claim 1, wherein:
each of said first and second optical elements comprises a prism plate; and
said beam direction controlling device is configured to enable a relative rotation about the optical axis of the beam direction controlling device, between said first and second optical elements.

6. The beam direction controlling device according to claim 5, further configured to enable joint rotation of said first and second optical elements about the optical axis of the beam direction controlling device, while maintaining a constant angular displacement between said first and second optical elements.

7. The beam direction controlling device according to claim 1, wherein the first face of each of said first and second optical elements is substantially planar and the second face of each of said first and second optical elements has a prism structure formed thereon.

8. The beam direction controlling device according to claim 1, wherein:
said first optical element comprises a first lenticular array comprising a plurality of focusing lenticulars;
said second optical element comprises a second lenticular array; and
said beam direction controlling device is configured to enable a relative lateral displacement between said first and second optical elements in a plane perpendicular to the optical axis of the beam direction controlling device.

9. The beam direction controlling device according to claim 8, wherein the second lenticular array has a substantially equal pitch as the first lenticular array.

10. The beam direction controlling device according to claim 9, configured to allow a maximum relative lateral displacement between said first and second optical elements being smaller than or equal to the pitch (p) of the first and second lenticular arrays.

11. The beam direction controlling device according to claim 8, wherein the second lenticular array comprises a plurality of focusing lenticulars.

12. The beam direction controlling device according to claim 11, wherein each of the lenticulars in the second optical element comprises:
a first portion configured to provide total internal reflection of said light-rays impinging on the second optical element in said primary direction; and
a second portion configured to refract said light-rays.

13. The beam direction controlling device according to claim 8, configured to enable changing the distance between the first and second optical elements, to thereby enable control of the divergence of the light-beam.

14. The beam direction controlling device according to claim 8, further comprising a third optical element arranged between said first and second optical elements, the third optical element comprising a third lenticular array.

15. A light-output device comprising:
the beam direction controlling device according to claim 1; and
a light-source arranged to emit light passing through said beam direction controlling device.
